(19) United States
(12) Patent Application Publication
(10) Pub. No.: US 2004/0124082 A1
(43) Pub. Date: Jul. 1, 2004

(54) Gas sensor having improved structure for minimizing thermal damage to hermetic seal

(75) Inventor: Kazuya Nakagawa, Kariya-shi (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref. (JP)

(21) Appl. No.: 10/737,876

(22) Filed: Dec. 18, 2003

(30) Foreign Application Priority Data
Sep. 25, 2003 (JP) 2003-333696
Dec. 20, 2002 (JP) 2002-370190

(51) Int. Cl. G01N 27/26

(52) U.S. Cl. 204/424; 204/426

(57) ABSTRACT

An improved structure of a gas sensor is provided which is designed to form an air-tight seal in a base end of a sensor body which is insensitive to heat. The gas sensor includes a seal assembly made up of an elastic seal and a heat-resistant support. The heat-resistant support is located closer to the top of the gas sensor than the elastic seal to protect the elastic seal from the heat transmitted to the base end from the top of the sensor body. The elastic seal is disposed within the base end of the sensor body and compressed constantly to produce a reactive force which serves to create the air-tight seal in the base end of the gas sensor through which lead wires pass.

### BACKGROUND OF THE INVENTION

1. Technical Field of the Invention

The present invention relates generally to a gas sensor which may be installed in an exhaust pipe of automotive engines to measure the concentration of gas such O₂, NOx, or CO, and more particularly to an improved structure of such a gas sensor which is designed to minimize thermal damage to a hermetic seal in a base end of a sensor body from which a lead wire extends.

2. Background Art

Gas sensors are know which are installed in an exhaust pipe of automotive engines for use in air-fuel ratio control of the engine.

FIG. 14 shows one example of such a type of gas sensors which is taught in Japanese Patent First Publication No. 11-72472 (corresponding to U.S. Pat. No. 6,150,607, issued Nov. 21, 2000).

The gas senor 9 has installed therein a sensor element (not shown) which is electrically connected to an external control device through leads 16 for transmitting a sensor output and receiving electric power therefrom. The gas sensor 9 has a seal member 97 made of rubber or resin which forms an air-tight seal between the leads 16 and an inner wall of an open base end of the gas sensor 9. The seal member 97 is retained within an air cover 92 by crimping a side wall of the air cover 92.

In a case where the gas sensor 9 is installed in the exhaust pipe of the automotive engine, a top portion of the gas sensor is exposed to a hot exhaust gas, so that it is heated up. The heat is transmitted to the base end of the gas sensor 1, which may result in thermal deformation or change in coefficient of elasticity of the seal member 97. This may cause an air gap to be formed between the seal member 97 and the inner wall of the air cover, thus decreasing the degree of sealing therebetween and the leads 16 to be shifted in position or dislodged from the base end of the air cover 92.

### SUMMARY OF THE INVENTION

It is therefore a principal object of the present invention to avoid the disadvantages of the prior art.

It is another object of the present invention to provide an improved structure of a gas sensor designed to form a hermetic seal in an end of a sensor body which is insensitive to heat.

According to one aspect of the invention, there is provided a gas sensor which may be installed in an exhaust pipe of automotive engines to measure the concentration of a given component of exhaust gasses of the engine. The gas sensor has a length with a first and a second end opposed to the first end and comprises: (a) a hollow cylindrical housing having a length with a first end facing the first end of the gas sensor and a second end facing the second end of the gas sensor; (b) a sensor element retained in the housing, the sensor element having a length made up of a base portion and a sensing portion which works to measure a concentration of a given component of gasses; (c) a measurement gas side cylindrical cover joined to the first end of the housing to cover the sensing portion of the sensor element; (d) an atmosphere side cylindrical cover having a length with a first end facing the first end of the gas sensor and a second end facing the second end of the gas sensor, the atmosphere side cylindrical cover being installed at the first end thereof on the second end of the housing to cover the base portion of the sensor element; (e) an end cover formed on the second end of the atmosphere side cylindrical cover; and (f) a seal assembly working to retain a lead hermetically therewithin which is electrically connected to the sensor element for transmitting an output of the sensor element to or receiving electric power from an external device. The seal assembly is made up of an elastic seal and a heat-resistant support. The elastic seal includes a disc portion which has a first end facing the first end of the gas sensor and a second end facing the second end of the gas sensor and is placed in abutment of the second end thereof with the end cover and a cylindrical seal portion within which the lead is fitted and which has a length with a first end facing the first end of the gas sensor and a second end facing the second end of the gas sensor. The cylindrical seal portion extends from the disc portion in a longitudinal direction of the gas sensor and has an outer diameter decreasing from the second end to the first end thereof. The heat-resistant support is made up of a hollow cylindrical body and a disc-shaped support formed on the hollow cylindrical body, disposed within the atmosphere side cylindrical cover, and born by the housing through an inner support member. The hollow cylindrical body has an inner surface substantially contoured to conform with a contour of an outer surface of the cylindrical seal portion of the elastic seal so that the cylindrical seal portion is fitted within the hollow cylindrical body hermetically. The disc-shaped support is placed in abutment with the disc portion of the elastic seal. The elastic seal is compressed elastically between the end cover and the heat-resistant support in the longitudinal direction of the gas sensor to produce a reactive force which serves to ensure hermetic seals between the lead and the cylindrical seal portion and between the end cover and the elastic seal.

In the preferred mode of the invention, the gas sensor may further comprise a heat-resistant elastic member disposed between the heat-resistant support and the inner support member. As already discussed in the introductory part of this application, in the case where the gas sensor is installed in the exhaust pipe of the engine, the top of the gas sensor is the highest in temperature. Installation of the heat-resistant elastic member closer to a heat source than the seal assembly serves to protect the hermetic seals against the heat.

The end cover has formed therein a hole through which the lead passes. The hole has a cross section in a direction perpendicular to the longitudinal direction of the gas sensor which is substantially similar in shape to an opening formed in the second end of the cylindrical seal portion of the elastic seal. This results in a maximized area of contact between the end cover and the cylindrical seal portion, thus increasing an area of the end cover pressing the cylindrical seal portion to enhance the degree of sealing between the end cover and the cylindrical seal portion.

The second end of the disc portion of the elastic seal may have a flat surface abutting with the end cover, thereby resulting in a decrease in production cost of the elastic seal and also minimizing thermal damage or breakage of the elastic seal.

The end cover has an annular protrusion around a periphery of the hole thereof which presses a periphery of an opening formed in the second end of the cylindrical seal portion of the elastic seal, thereby enhancing the degree of sealing between the end cover and the cylindrical seal portion.

The portion of the elastic seal may have an annular recess formed in the second end thereof around the opening of the cylindrical seal portion. The annular protrusion of the end cover is fitted within the annular recess hermetically.

The cylindrical seal portion of the elastic seal may have an annular protrusion formed around an opening formed in the second end thereof. The annular protrusion is fitted in an opening formed in the end cover hermetically, thereby enhancing the degree of sealing between the end cover and the cylindrical seal portion.

The end cover has an inner end surface placed in abutment with the second end of the disc portion of the elastic seal. The disc portion is placed in abutment of the first end with the second end of the disc-shaped support of the heat-resistant support. The disc-shaped support is placed in abutment of the first end thereof with an end of the inner support member facing the second end of the gas sensor. The end cover may have formed on the inner end surface thereof a rib which projects to the second end of the disc portion of the elastic seal to establish a hermetic seal between the inner end surface of the end cover and the second end surface of the disc portion.

The rib may be circular in shape. The disc portion of the elastic seal has formed in the second end thereof an annular groove within which the rib is fitted hermetically.

The heat-resistant support may be made of an electric insulating material, thereby avoiding leakage of current from the head to any parts of the gas sensor and dielectric breakdown causing a failure in operation of the gas sensor.

The cylindrical seal portion may have a rib formed on an inner surface which abuts the lead to establish a hermetic seal therebetween.

According to the second aspect of the invention, there is provided a gas sensor which has a length with a first and a second end opposed to the first end. The gas sensor comprises: (a) a hollow cylindrical housing having a length with a first end facing the first end of the gas sensor and a second end facing the second end of the gas sensor; (b) a sensor element retained in the housing, the sensor element having a length made up of a base portion and a sensing portion which works to measure a concentration of a given component of gasses; (c) a measurement gas side cylindrical cover joined to the first end of the housing to cover the sensing portion of the sensor element; (d) an atmosphere side cylindrical cover having a length with a first end facing the first end of the gas sensor and a second end facing the second end of the gas sensor, the atmosphere side cylindrical cover being installed at the first end thereof on the second end of the housing to cover the base portion of the sensor element; (e) an end cover formed on the second end of the atmosphere side cylindrical cover; and (f) a seal assembly working to retain a lead hermetically therewithin which is electrically connected to the sensor element for transmitting an output of the sensor element to or receiving electric power from an external device. The seal assembly is made up of an elastic seal and a heat-resistant support. The elastic seal includes a disc portion which has a first end facing the first end of the gas sensor and a second end facing the second end of the gas sensor and is placed in abutment of the second end thereof with the end cover and a cylindrical seal portion within which the lead is fitted and which has a first end facing the first end of the gas sensor and a second end facing the second end of the gas sensor. The cylindrical seal portion extends from the disc portion in a longitudinal direction of the gas sensor. The heat-resistant support includes a hollow cylindrical body, disposed within, and born by the atmosphere side cylindrical cover from a side of the second end of the gas sensor. The heat-resistant support has a first end facing the first end of the gas sensor and a second end facing the second end of the gas sensor. The heat-resistant support is placed in abutment of the second end thereof with first end of the cylindrical seal portion of the elastic seal. The elastic seal is compressed elastically between the end cover and the heat-resistant support in the longitudinal direction of the gas sensor to produce a reactive force which serves to ensure hermetic seals between the lead and the cylindrical seal portion and between the end cover and the elastic seal.

In the preferred mode of the invention, the end cover has formed therein a hole through which the lead passes. The hole has a cross section in a direction perpendicular to the longitudinal direction of the gas sensor which is substantially similar in shape to an opening formed in the second end of the cylindrical seal portion of the elastic seal.

The second end of the disc portion of the elastic seal may have a flat surface abutting with the end cover.

The end cover has an annular protrusion around a periphery of the hole thereof which presses a periphery of an opening formed in the second end of the cylindrical seal portion of the elastic seal.

The disc portion of the elastic seal may have an annular recess formed in the second end thereof around the opening of the cylindrical seal portion. The annular protrusion is fitted within the annular recess to establish an air-tight seal therebetween.

The cylindrical seal portion of the elastic seal may have an annular protrusion formed around an opening formed in the second end thereof. The annular protrusion is fitted in an opening formed in the end cover, thereby creating an air-tight seal therebetween.

The cover has an inner end surface placed in abutment with the second end of the disc portion of the elastic seal. The disc portion is placed in abutment of the first end with the second end of the hollow cylindrical body of the heat-resistant support. The hollow cylindrical body is supported at the first end thereof by the atmosphere side cylindrical cover and urging the first end of the disc portion of the elastic seal through a hollow cylinder to compress the elastic seal, thereby producing the reactive force. The end cover has formed on the inner end surface thereof a rib which projects to the second end of the disc portion of the elastic seal to establish a hermetic seal between the inner end surface of the end cover and the second end surface of the disc portion.

The rib may be circular in shape. The disc portion of the elastic seal has formed in the second end thereof an annular groove within which the rib is fitted hermetically to establish an air-tight seal therebetween.

The heat-resistant support may be made of an electric insulating material.

The cylindrical seal portion may have a rib formed on an inner surface which abuts the lead to establish a hermetic seal therebetween.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a gas sensor according to the first embodiment of the invention;

FIG. 2 is a partially sectional view which shows a structure of a hermetic seal in an open end of the gas sensor of FIG. 1;

FIG. 3 is an exploded sectional view which shows a seal assembly installed in the open end of the gas sensor, as illustrated in FIG. 2;

FIG. 4(a) is a top view which shows an elastic seal of the seal assembly, as illustrated in FIG. 3;

FIG. 4(b) is a side view of FIG. 4(a);

FIG. 5(a) is a top view which shows an end cover of the gas sensor, as illustrated in FIG. 1;

FIG. 5(b) is a side view of FIG. 5(a);

FIG. 6(a) is a top view of a washer installed in the gas sensor, as illustrated in FIG. 1;

FIG. 6(b) is a side view of FIG. 6(a);

FIG. 7 is a longitudinal sectional view which shows a gas sensor according to the second embodiment of the invention;

FIG. 8(a) is a top view which shows an elastic seal installed in the gas sensor, as illustrated in FIG. 7;

FIG. 8(b) is a vertical sectional view which shows the elastic seal of FIG. 8(a);

FIG. 8(c) is a vertical sectional view which shows a heat-resistant support installed in the gas sensor, as illustrated in FIG. 7;

FIGS. 9(a) and 9(b) are partially sectional views which shows sequential steps of installation of a seal assembly in the gas sensor, as illustrated in FIG. 7;

FIG. 10 is a partially vertical sectional view which shows a structure of a hermetic seal in a base end of a gas sensor according to the third embodiment of the invention;

FIG. 11 is a partially vertical sectional view which shows a structure of a hermetic seal in a base end of a gas sensor according to the fourth embodiment of the invention;

FIG. 12 is a partially vertical sectional view which shows a structure of a hermetic seal in a base end of a gas sensor according to the fifth embodiment of the invention;

FIG. 13 is a top view of FIG. 12; and

FIG. 14 is a partially vertical sectional view which shows a structure of a hermetic seal formed in a base end of a conventional gas sensor.

### DESCRIPTION OF THE PREFERRED EMBODIMENTS

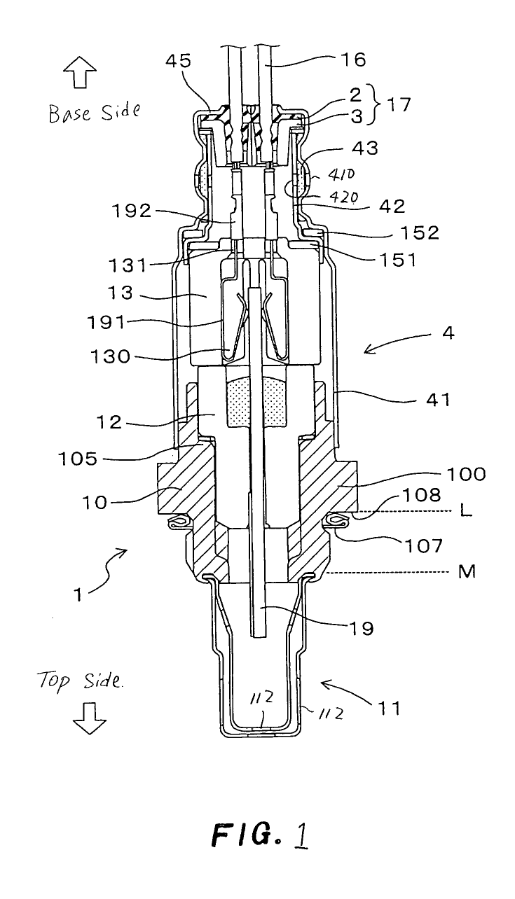

Referring now to the drawings, wherein like numbers refer to like parts in several views, particularly to FIG. 1, there is shown a gas sensor 1 according to the first embodiment of the invention which may be employed in automotive air-fuel ratio control systems to measure O₂, HC, CO, or NOx contained in exhaust gasses of an internal combustion engine.

The gas sensor 1 generally includes a gas sensor element 19 working to measure a preselected component of gasses, a hollow cylindrical housing 10 retaining therein the gas sensor element 19, a protective cover assembly 11 installed on a head end of the housing 10 to cover a head portion (i.e., a sensing portion) of the gas sensor element 19, a cylindrical air cover 4 installed on a base end of the housing 10 to cover a base portion of the gas sensor element 19, and a seal assembly 17 fitted hermetically within an open end of the air cover 4. The seal assembly 7 also works to retain leads 16 connecting electrically between the gas sensor element 19 and an external sensor controller (not shown) to transmit a sensor output to and receive electric power from the sensor controller.

The seal assembly 17 consists of an elastic seal 2 and a heat-resistant support 3. The elastic seal 2 is, as clearly shown in FIG. 3, made up of disc-shaped support 21 (will also be referred to as a flange below) and four hollow cylindrical lead seals 22. Each of the lead seals 22 extends in a longitudinal direction of the gas sensor 1 and has an outer diameter which decreases from a base end (i.e., an upper end, as viewed in FIG. 3) joined to the flange 21 to a top end (i.e., a lower end, as viewed in FIG. 3). Each of the lead seals 22 retains therein one of the leads 16 hermetically.

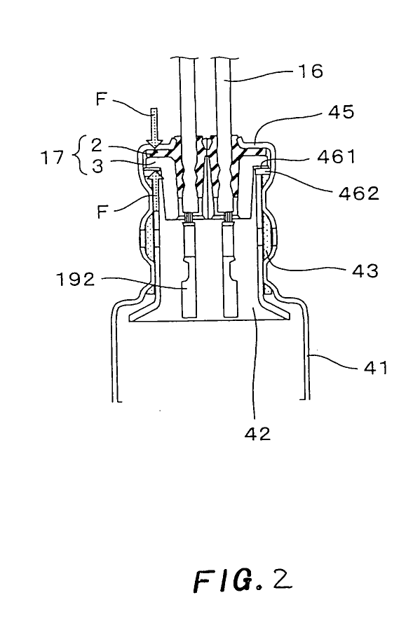

The heat-resistant support 3 is made up of a disc-shaped support 31 (will also be referred to as a flange below) and a cylindrical body 32. The cylindrical body 32 has formed therein four cylindrical through holes 333 within which the lead seals 22 of the elastic seal 2 are to be fitted. The heat-resistant support 3 is, as can be seen from FIGS. 1 and 2, disposed within a small-diameter portion of the air cover 4 and born by an inner cover 42 supported indirectly by the housing 10. The heat-resistant support 3 may be made of an electric insulating material in order to avoid leakage of current from the heads 16 to any parts of the gas sensor 1 and dielectric breakdown causing a failure in operation of the gas sensor 1.

The circular flange 31 has a base end surface 311 which abuts a top end surface 212 of the circular flange 21 of the elastic seal 2. The cylindrical body 32 has inner side surfaces 322 each of which is substantially contoured to conform with the contour of one of the lead seals 22 so that the lead seal 22 is fitted within the through hole 333 hermetically.

The air cover 4 includes, as shown in FIG. 1, an end cover 45 which abuts to a base end surface 211, as shown in FIG. 3, of the circular flange 21 of the elastic seal 2.

A reactive force produced by compressive presses, as indicated by arrows F in FIG. 2, acting on the circular flange 211 of the elastic seal 2 in opposite directions parallel to the longitudinal center line of the gas sensor 1 between the end cover 45 and the flange 31 of the heat-resistant support 3 works to form air-tight seals between the leads 16 and the cylindrical lead seals 22 and between the flange 211 and the end cover 45 of the air cover 4.

The gas sensor 1 is installed, for example, in a wall of an exhaust pipe joining to an automotive engine to determine an air-fuel ratio for use in air-fuel ratio control of the engine. In the installation of the gas sensor 1, an end surface 108 of a flange 100 of the housing 10, as illustrated in FIG. 1, is placed in abutment to an outer surface of the exhaust pipe through a spring 107. The spring 107 works to provide hermetic sealing between the end surface 108 and the outer surface of the exhaust pipe.

When the engine is running, a lower portion of the gas sensor 1 below a broken line Min FIG. 1, is exposed to exhaust gasses flowing through the exhaust pipe and heated thereby. An upper portion of the gas sensor 1 above a broken line L is exposed to the atmospheric air. The temperature of the gas sensor 1, thus, decreases gradually from the broken line L to the base end of the gas sensor 1 (i.e., the upper end, as viewed in FIG. 1).

The protective cover assembly 11 is of a double-walled structure and made up of an outer cylindrical cover and an inner cylindrical cover disposed within the outer cover coaxially with each other. The outer and inner covers, as shown in FIG. 1, have gas holes 112 through which the exhaust gasses pass and enter inside a gas chamber defined in the inner cover. The gas sensor element 19 has a head portion (i.e., a sensing portion) exposed to the exhaust gasses in the inner cover. The protective cover assembly 11 may alternatively be of a single- or multi-walled (more than two) structure.

The gas sensor element 19 is retained within the housing 10 through the insulation porcelain 12. Gas-tight seals are formed between the insulation porcelain 12 and the housing 10 and between the insulation porcelain 12 and the gas sensor element 19.

The insulation porcelain 13 is disposed within the air cover 4 in alignment with the insulation porcelain 12. The insulation porcelain 13 has formed therein a cavity 130 within which a base portion of the gas sensor element 19 is disposed. The insulation porcelain 13 has formed in a base end thereof holes 131 leading to the cavity 130.

The gas sensor element 19 connects with leads 16 through terminals 191 and connectors 192 such as clamp contacts for transmitting an output of the gas sensor element 19 to and receiving electric power from an external sensor controller (not shown). The terminals 191 pass through the holes 131 and extend into an air chamber formed inside a base portion of the air cover 4 above the insulation porcelain 13. Within the air chamber, the terminals 191 are joined electrically to the leads 16 through the connectors 192. The leads 16 extend through the seal assembly 17 and connect with the external sensor controller.

A disc spring 151 is placed on the base end of the insulation porcelain 13. The disc spring 151 is urged elastically by the insulation porcelain 13 and a shoulder of the inner cover 42 to produce a spring pressure.

The elastic seal 2, as can be seen in FIG. 3, includes the circular flange 21 and the cylindrical lead seals 22. The lead seals 22 extend from the flange 21 in parallel to the longitudinal center line of the gas sensor 1. Each of the lead seals 22 has an outer wall which tapers off to the top end thereof (i.e., the lower end as viewed in the drawing). Each of the lead seals 22 has two annular ribs 2220 formed on an inner wall 222 thereof which work to retain the leads 16 hermetically.

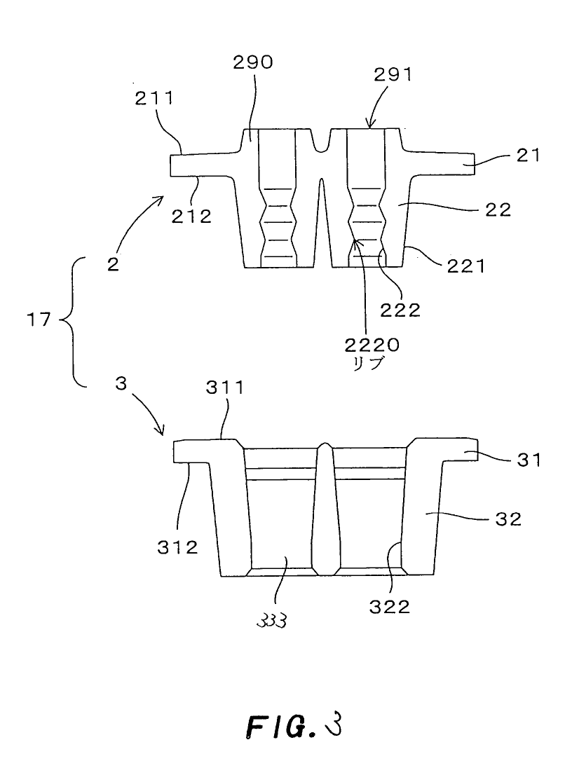

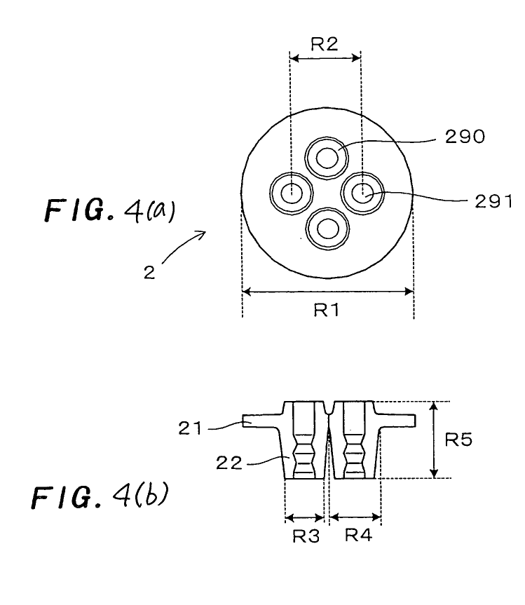

Each of the lead seals 22 also has an annular boss 290 which extends upward, as viewed in the drawing, from the flange 21 toward the end cover 45. Each of the lead seals 22 has formed therein, as clearly shown in FIG. 4(a), an opening 291 for insertion of one of the leads 16.

The outer diameter R1 of the elastic seal 2 (i.e., the flange 21), as shown in FIG. 4(a), is 13 mm. The center-to-center pitch R2 of two of the openings 291 diametrically opposed to each other is 5.4 mm. The minimum outer diameter R3, as shown in FIG. 4(b), of the cylindrical lead seals 22 is 3 mm. The maximum outer diameter R4 of the cylindrical lead seals 22 (i.e., the base end just beneath the flange 21) is 4 mm. The total height R5 of the elastic seal 2 is 5.4 mm.

The heat-resistant support 3 is, as shown in FIG. 3, made up of the flange 31 and the cylindrical body 32.

The flange 31 has the base end surface 311 which abuts the top end surface 212 of the flange 21 of the elastic seal 2 and the cylindrical body 32 which has the four through holes 333 within which the cylindrical lead seals 22 are fitted, respectively. The cylindrical body 32 has cylindrical inner surfaces 322 which define the through holes 333 and are contoured to conform with the contour of the lead seals 22 of the elastic seal 2 for guiding insertion of the lead seals 22 when the elastic seal 2 and the heat-resistant support 3 are assembled. The lead seals 22 have the outer diameter slightly greater than the diameter of the through holes 333 which establishes a press fit of the lead seals 22 within the through holes 333 to enhance the degree of sealing between the lead seals 22 and the through holes 333.

The main cover 41 of the air cover 4, as clearly shown in FIGS. 5(a) and 5(b), has the end cover 45 formed integrally. The end cover 45 has an outer end surface 451 exposed outside the gas sensor 1 and an inner end surface 452 which abuts to the base end surface 211 of the flange 21 of the elastic seal 2. The end cover 45 has formed therein four lead insertion holes 459 which coincide with the openings 291 of the elastic seal 2, respectively, when installed within the air cover 4 and annular protrusions 450 each of which extends around the periphery of one of the lead insertion holes 459. The holes 459 are circular, like the openings 291 of the elastic seal 2, thereby resulting in a maximized area of the end cover 45 working to press the elastic seal 2 elastically with aid of the inner cover 42 to create the air-tight seal between the end cover 45 and the elastic seal 2

The elastic seal 2, as described above, has the annular bosses 290 which are, as shown in FIG. 2, press-fitted within the lead insertion holes 459 to form air-tight seals between the leads 16 and the lead insertion holes 450.

The seal assembly 17 is, as already described, made up of the elastic seal 2 and the heat-resistant support 3. The elastic seal 2 is disposed within the main cover 41 of the air cover 4 and urged elastically between the end cover 45 and the base end of the inner cover 42 through the heat-resistant support 3 and the washers 461 and 462, thereby enhancing the degree of air-tight sealing between the leads 16 and the lead seals 22 of the elastic seal 2 and between the end cover 45 and the elastic seal 2. The washers 461 and 462 may be made of a heat-resistant material such as a stainless steel in order to protect the seal assembly 17 from the heat transmitted from the top of the gas sensor 1 when installed in the exhaust pipe of the automotive engine, thereby ensuring the sealing ability of the seal assembly 17. Instead of the washers 461 and 462, disc springs or leaf springs may be employed.

The heat-resistant support 3 is held by the housing 10 through the insulator porcelains 12 and 13 and the inner cover 42. The heat-resistant support 3 works to urge the elastic seal 2 elastically into constant abutment with the end cover 45.

In a case where the gas sensor 1 is installed in the exhaust pipe of the automotive engines, the temperature of the gas sensor 1 drops from the top end (i.e., the protective cover assembly 11) to the base end (i.e., the end cover 45) thereof. In other words, the base end of the gas sensor 1 is located farther away form a heat source. The heat-resistant support 3 is located closer to the heat source than the elastic seal 2, thereby protecting the air-tight seals produced by the elastic seal 2 against the heat.

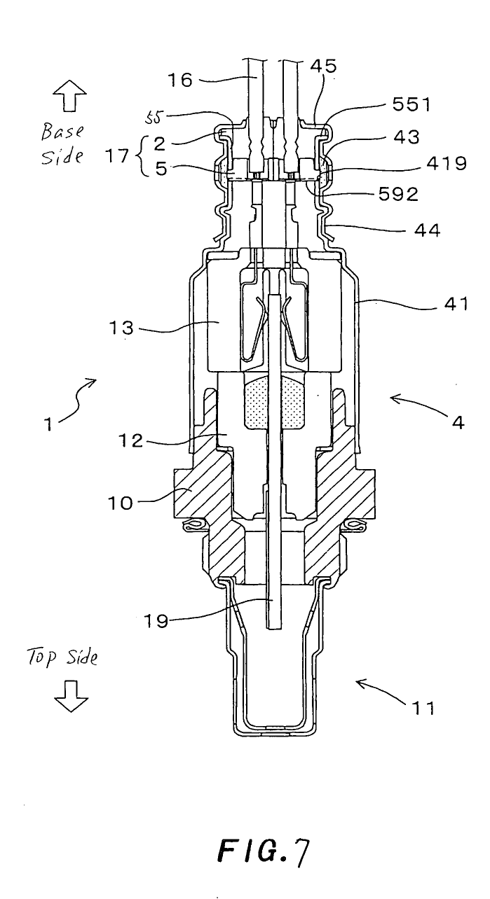

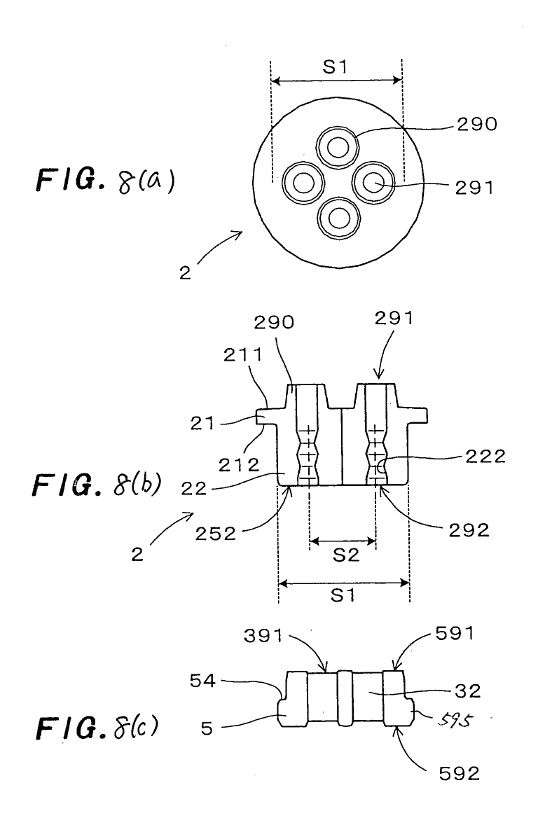

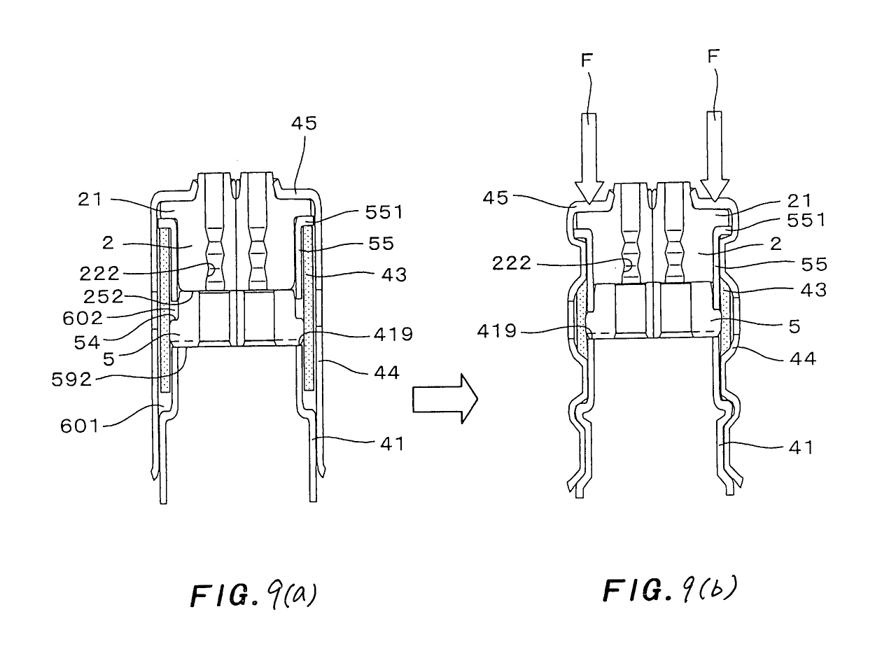

FIGS. 7 to 9(b) show the gas sensor 1 according to the second embodiment of the invention.

The gas sensor 1 consists essentially of the gas sensor element 19, the hollow cylindrical housing 10 retaining therein the gas sensor element 19, the protective cover assembly 11 installed on the head end of the housing 10, the cylindrical air cover 4 installed on the base end of the housing 10, and the seal assembly 17 fitted hermetically within the open end of the air cover 4. The seal assembly 7, like the first embodiment, works to retain the leads 16 connecting electrically between the gas sensor element 19 and an external sensor controller (not shown) to transmit a sensor output to and receive electric power from the sensor controller and to establish the hermetic seals between the leads 16 and the elastic seal 2 and between the elastic seal 2 and the end cover 45 of the air cover 4.

The air cover 4 includes the cylindrical main cover 41 welded to the side wall of the base end of the housing 10 and the cylindrical filter cover 44. The main cover 41 is welded directly to the side wall of the base portion of the housing 10. The filter cover 44 is secured to the outer surface of the small-diameter portion of the main cover 41 and crimped to retain the water-repellent filter 43 on the periphery of the main cover 41. The main cover 41 and the filter cover 44 have formed therein air vents through which air is admitted into the air chamber defined inside the small-diameter portion of the main cover 41.

The seal assembly 17 is disposed between the base end 419 of the main cover 41 and the end cover 45 formed integrally with the filter cover 44. The seal assembly 17 is made up of the elastic seal 2 and the heat-resistant support 5.

The elastic seal 2 includes, as clearly shown in FIGS. 8(a) and 8(b), a disc 21 and cylindrical lead seals 290. The lead seals 290 extend through the disc 21 in a direction parallel to the longitudinal center line of the gas sensor 1 and work to retain the leads 16 hermetically.

The heat-resistant support 5 is, as shown in FIG. 8(c), a cylindrical member which has four cylindrical through holes 32 formed therein and a flange 595. The holes 32 have openings 391 which communicate with openings 292 of the lead seals 22, respectively when the heat-resistant support 5 and the elastic seal 2 are assembled, as illustrated in FIG. 7.

The heat-resistant support 5 is, as shown in FIG. 7, disposed within the air cover 4 and born by the housing 10 through the main cover 41. Specifically, the main cover 41 bears the heat-resistant support 5 in abutment of the base end 419 thereof with the top end surface 592 of the heat-resistant support 5.

The heat-resistant support 5 has the base end surface 591 abutting to the top end surfaces 252 of the lead seals 22 of the elastic seal 2.

The heat-resistant support 5 has a shoulder 54 formed on an outer side wall thereof. A metallic sleeve 55 is disposed within the main cover 41 in abutment of a lower end thereof to the shoulder 54 of the heat-resistant support 5. The metallic sleeve 55 has a flange 551 extending in a radius direction of the gas sensor 1 which abuts to the end surface 212 of the disc 21 of the elastic seal 2. Specifically, the metallic sleeve 55 works as a support member which supports the disc 21 of the elastic seal 2 elastically to create an air-tight seal between the inner surface of the end cover 45 and the end surface of the disc 21.

The filter cover 44, as already described, has the end cover 45 which abuts the end surface 211 of the disc 21 of the elastic seal 2.

A total outer diameter S1, that is, a distance between peripheries of diametrically opposed two of the lead seals 291 is 10 mm. A center-to-center pitch S2 of the openings 292 of the lead seals 291 is 5.4 mm.

Installation of the seal assembly 17 is achieved in the following steps.

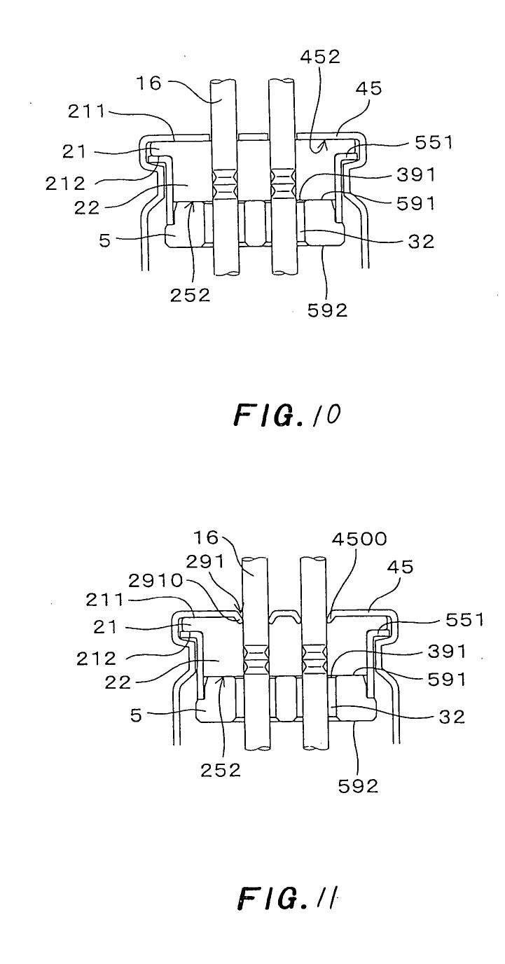

First, the elastic seal 2 is, as shown in FIG. 9(a), disposed on the heat-resistant support 5 within the filter cover 44 with the disc 21 placed between the end cover 45 and the flange 551 of the metallic sleeve 55. The heat-resistant support 5 is born by the base end 419 of the main cover 41. The water-repellent filter 43 is disposed between the side wall of the filter cover 44 and the side walls of the metallic sleeve 55, the heat-resistant support 5, and the main cover 41. The water-repellent filter 43 is separate at the lower end thereof from the shoulder of the main cover 41 through an air gap 601. The metallic sleeve 55 is separate at the lower end thereof from the shoulder 54 of the heat-resistant support 5 through an air gap 602. Although not illustrated, in this step, the leads 16 are inserted into the elastic seal 2 and the heat-resistant support 5.

Next, pressure is applied, as indicated by arrows Fin FIG. 9(b), to the end cover 45 to compress it until the air gaps 601 and 602 disappear and reactive forces are created which act on the metallic sleeve 55 and the water-repellent filter 43. The reactive force acting on the metallic sleeve 55 causes the diameter of the inner side walls 222 of the lead seals 22 to be decreased, thereby enhancing the degree of sealing between the inner wide walls 222 and the leads 16.

Finally, the side walls of the filter cover 44 and the main cover 41 are, as shown in FIG. 9(b), crimped to retain the water-repellent filter 43 and to keep the above reactive forces at constant levels.

The structure of the gas sensor 1 of this embodiment, like the first embodiment, has the elastic seal 2 located farther away from the heat source than the heat-resistant support 5 to protect the air-tight seals produced by the elastic seal 2 against the heat. Other arrangements are identical with those in the first embodiment, and explanation thereof in detail will be omitted here.

FIG. 10 shows the gas sensor 1 according to the third embodiment of the invention which is different from the second embodiment only in that the end cover 45 has a flat inner surface 452, and the disc 21 of the elastic seal 2 has a flat surface 211 placed in abutment with the inner surface 452 of the end cover 45. Other arrangements are identical, and explanation thereof in detail will be omitted here.

The structure of this embodiment provides the simplicity of shape of the elastic seal 2, thus resulting in ease of machining of the elastic seal 2 and also minimizing thermal damage or breakage of the elastic seal 2.

FIG. 11 shows the gas sensor 1 according to the fourth embodiment of the invention which is a modification of the third embodiment.

The elastic seal 2 has annular grooves 2910 formed around the openings 291. The end cover 45 of the air cover 4 has annular protrusions 4500 fitted firmly within the annular grooves 2910, respectively, thereby increasing the degree of sealing between the end cover 45 and the disc 21 of the elastic seal 2. The annular grooves 2910 may alternatively be omitted, while the annular protrusions 4500 may press the flat end surface 211 of the disc 21 to create an air-tight seal between the inner surface of the end cover 45 and the end surface 211 of the disc 21.

Other arrangement are identical with those in the third embodiment, and explanation thereof in detail will be omitted here.

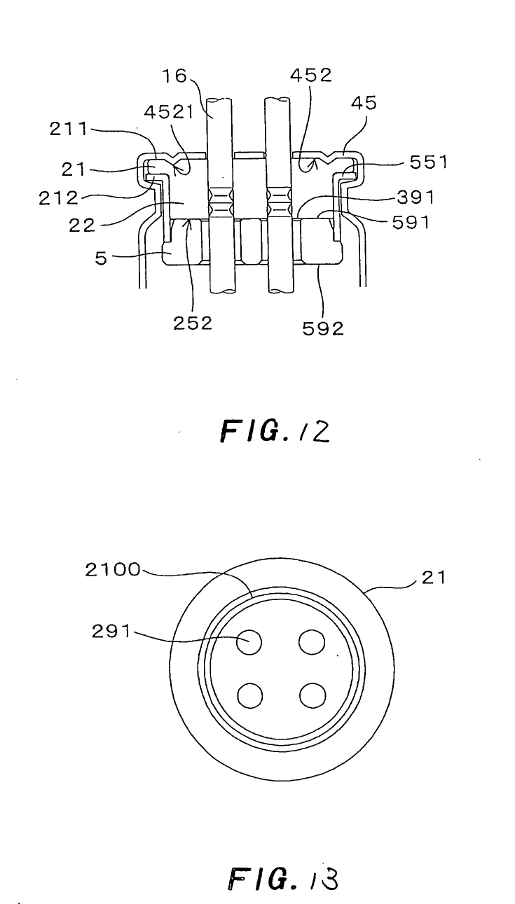

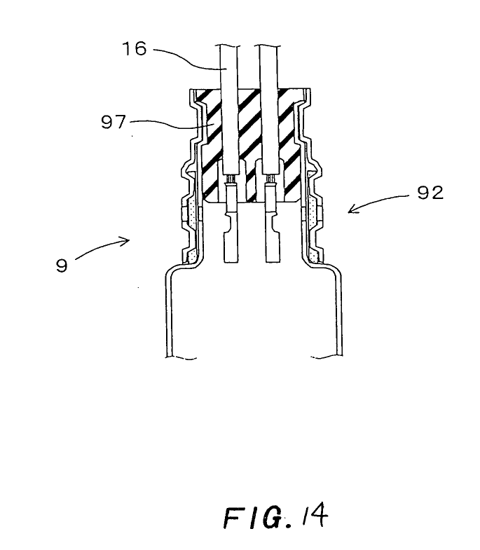

FIGS. 12 and 13 show the gas sensor 1 according to the fifth embodiment of the invention which is a modification of the third embodiment.

The disc 21 of the elastic seal 2 has, as clearly shown in FIG. 13, an annular seal groove 2100 formed in the flat end surface 211 coaxially with the outer periphery of the disc 21. The end cover 45 of the air cover 4 has formed on the inner surface 452 an annular seal rib (i.e., a protrusion) 4521 which is fitted within the annular groove 2100 to form an air-tight seal between the end surface 211 of the disc 21 of the elastic seal 2 and the end cover 45 of the air cover 4.

The annular seal grooves 2100 may alternatively be omitted, while the annular seal rib 4521 may press the flat end surface 211 of the disc 21 to create an air-tight seal between the inner surface 452 of the end cover 45 and the end surface 211 of the disc 21.

Other arrangements are identical with those in the third embodiment, and explanation thereof in detail will be omitted here.

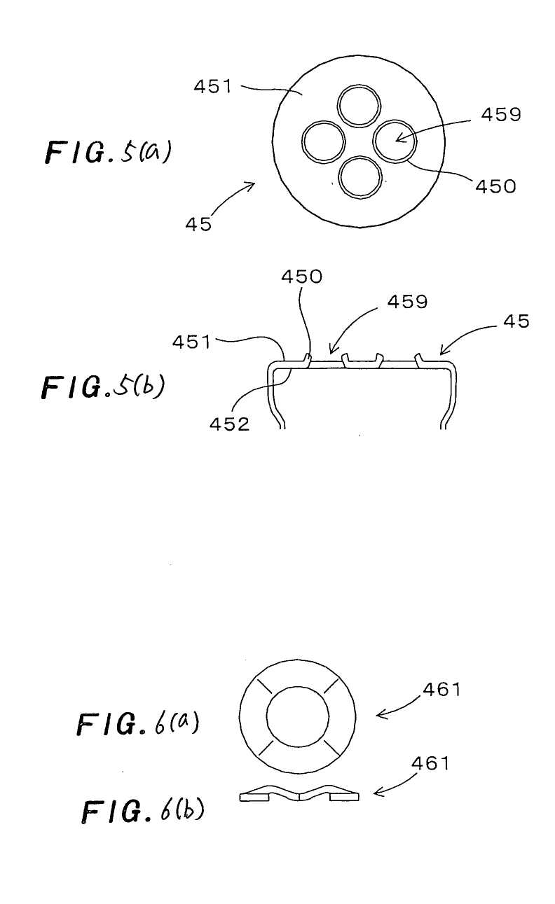

The structures of the end cover 45 and the elastic seal 2 in the third to fifth embodiment may also be used in the first embodiment as illustrated in FIGS. 1 to 6.

The gas sensor element 19 may be made of a laminated plate such as one taught in U.S. Pat. No. 5,573,650, issued Nov. 12, 1996 to Fukaya et al., disclosure of which is incorporated herein by reference. The gas sensor element 19 may alternatively be made of a known cup-shaped sensor element.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas sensor having a length with a first and a second end opposed to the first end, comprising:
a hollow cylindrical housing having a length with a first end facing the first end of the gas sensor and a second end facing the second end of the gas sensor;
a sensor element retained in said housing, said sensor element having a length made up of a base portion and a sensing portion which works to measure a concentration of a given component of gasses;
a measurement gas side cylindrical cover joined to the first end of said housing to cover the sensing portion of said sensor element;
an atmosphere side cylindrical cover having a length with a first end facing the first end of the gas sensor and a second end facing the second end of the gas sensor, said atmosphere side cylindrical cover being installed at the first end thereof on the second end of said housing to cover the base portion of said sensor element;
an end cover formed on the second end of said atmosphere side cylindrical cover; and
a seal assembly working to retain a lead hermetically therewithin which is electrically connected to said sensor element for transmitting an output of said sensor element to or receiving electric power from an external device, said seal assembly being made up of an elastic seal and a heat-resistant support, the elastic seal including a disc portion which has a first end facing the first end of the gas sensor and a second end facing the second end of the gas sensor and is placed in abutment of the second end thereof with said end cover and a cylindrical seal portion within which the lead is fitted and which has a length with a first end facing the first end of the gas sensor and a second end facing the second end of the gas sensor, the cylindrical seal portion extending from the disc portion in a longitudinal direction of the gas sensor and having an outer diameter decreasing from the second end to the first end thereof, the heat-resistant support being made up of a hollow cylindrical body and a disc-shaped support formed on the hollow cylindrical body, disposed within said atmosphere side cylindrical cover, and born by said housing through an inner support member, said hollow cylindrical body having an inner surface substantially contoured to conform with a contour of an outer surface of said cylindrical seal portion of said elastic seal so that said cylindrical seal portion is fitted within said hollow cylindrical body hermetically, the disc-shaped support being placed in abutment with the disc portion of said elastic seal, said elastic seal being compressed elastically between said end cover and said heat-resistant support in the longitudinal direction of the gas sensor to produce a reactive force which serves to ensure hermetic seals between the lead and the cylindrical seal portion and between said end cover and said elastic seal.

2. A gas sensor as set forth in claim 1, further comprising a heat-resistant elastic member disposed between said heat-resistant support and said inner support member.

3. A gas sensor as set forth in claim 1, wherein said end cover has formed therein a hole through which the lead passes, the hole having a cross section in a direction perpendicular to the longitudinal direction of the gas sensor which is substantially similar in shape to an opening formed in the second end of the cylindrical seal portion of said elastic seal.

4. A gas sensor as set forth in claim 1, wherein the second end of the disc portion of said elastic seal has a flat surface abutting with said end cover.

5. A gas sensor as set forth in claim 4, wherein said end cover has an annular protrusion around a periphery of the hole thereof which presses a periphery of an opening formed in the second end of the cylindrical seal portion of the elastic seal.

6. A gas sensor as set forth in claim 5, wherein the disc portion of said elastic seal has an annular recess formed in the second end thereof around the opening of the cylindrical seal portion, the annular protrusion being fitted within the annular recess.

7. A gas sensor as set forth in claim 1, wherein the cylindrical seal portion of said elastic seal has an annular protrusion formed around an opening formed in the second end thereof, the annular protrusion being fitted in an opening formed in said end cover.

8. A gas sensor as set forth in claim 1, wherein said end cover has an inner end surface placed in abutment with the second end of the disc portion of said elastic seal, the disc portion being placed in abutment of the first end with the second end of the disc-shaped support of the heat-resistant support, the disc-shaped support being placed in abutment of the first end thereof with an end of the inner support member facing the second end of the gas sensor, and wherein said end cover has formed on the inner end surface thereof a rib which projects to the second end of the disc portion of said elastic seal to establish a hermetic seal between the inner end surface of said end cover and the second end surface of the disc portion.

9. A gas sensor as set forth in claim 8, wherein the rib is circular in shape, and wherein the disc portion of said elastic seal has formed in the second end thereof an annular groove within which the rib is fitted hermetically.

10. A gas sensor as set forth in claim 1, wherein the heat-resistant support is made of an electric insulating material.

11. A gas sensor as set forth in claim 1, wherein the cylindrical seal portion has a rib formed on an inner surface which abuts the lead to establish a hermetic seal therebetween.

12. A gas sensor having a length with a first and a second end opposed to the first end, comprising:
a hollow cylindrical housing having a length with a first end facing the first end of the gas sensor and a second end facing the second end of the gas sensor;
a sensor element retained in said housing, said sensor element having a length made up of a base portion and a sensing portion which works to measure a concentration of a given component of gasses;
a measurement gas side cylindrical cover joined to the first end of said housing to cover the sensing portion of said sensor element;
an atmosphere side cylindrical cover having a length with a first end facing the first end of the gas sensor and a second end facing the second end of the gas sensor, said atmosphere side cylindrical cover being installed at the first end thereof on the second end of said housing to cover the base portion of said sensor element;
an end cover formed on the second end of said atmosphere side cylindrical cover; and
a seal assembly working to retain a lead hermetically therewithin which is electrically connected to said sensor element for transmitting an output of said sensor element to or receiving electric power from an external device, said seal assembly being made up of an elastic seal and a heat-resistant support, the elastic seal including a disc portion which has a first end facing the first end of the gas sensor and a second end facing the second end of the gas sensor and is placed in abutment of the second end thereof with said end cover and a cylindrical seal portion within which the lead is fitted and which has a first end facing the first end of the gas sensor and a second end facing the second end of the gas sensor, the cylindrical seal portion extending from the disc portion in a longitudinal direction of the gas sensor, the heat-resistant support including a hollow cylindrical body, disposed within, and born by said atmosphere side cylindrical cover from a side of the second end of the gas sensor, the heat-resistant support having a first end facing the first end of the gas sensor and a second end facing the second end of the gas sensor, the heat-resistant support being placed in abutment of the second end thereof with first end of the cylindrical seal portion of said elastic seal, said elastic seal being compressed elastically between said end cover and said heat-resistant support in the longitudinal direction of the gas sensor to produce a reactive force which serves to ensure hermetic seals between the lead and the cylindrical seal portion and between said end cover and said elastic seal.

13. A gas sensor as set forth in claim 12, wherein said end cover has formed therein a hole through which the lead passes, the hole having a cross section in a direction perpendicular to the longitudinal direction of the gas sensor which is substantially similar in shape to an opening formed in the second end of the cylindrical seal portion of said elastic seal.

14. A gas sensor as set forth in claim 12, wherein the second end of the disc portion of said elastic seal has a flat surface abutting with said end cover.

15. A gas sensor as set forth in claim 14, wherein said end cover has an annular protrusion around a periphery of the hole thereof which presses a periphery of an opening formed in the second end of the cylindrical seal portion of the elastic seal.

16. A gas sensor as set forth in claim 15, wherein the disc portion of said elastic seal has an annular recess formed in the second end thereof around the opening of the cylindrical seal portion, the annular protrusion being fitted within the annular recess.

17. A gas sensor as set forth in claim 12, wherein the cylindrical seal portion of said elastic seal has an annular protrusion formed around an opening formed in the second end thereof, the annular protrusion being fitted in an opening formed in said end cover.

18. A gas sensor as set forth in claim 11, wherein said end cover has an inner end surface placed in abutment with the second end of the disc portion of said elastic seal, the disc portion being placed in abutment of the first end with the second end of the hollow cylindrical body of the heat-resistant support, the hollow cylindrical body being supported at the first end thereof by said atmosphere side cylindrical cover and urging the first end of the disc portion of said elastic seal through a hollow cylinder to compress said elastic seal, thereby producing the reactive force, and wherein said end cover has formed on the inner end surface thereof a rib which projects to the second end of the disc portion of said elastic seal to establish a hermetic seal between the inner end surface of said end cover and the second end surface of the disc portion.

19. A gas sensor as set forth in claim 18, wherein the rib is circular in shape, and wherein the disc portion of said elastic seal has formed in the second end thereof an annular groove within which the rib is fitted hermetically.

20. A gas sensor as set forth in claim 12, wherein the heat-resistant support is made of an electric insulating material.

21. A gas sensor as set forth in claim 12, wherein the cylindrical seal portion has a rib formed on an inner surface which abuts the lead to establish a hermetic seal therebetween.
